(19) United States
(12) Patent Application Publication
(10) Pub. No.: US 2010/0284504 A1
(43) Pub. Date: Nov. 11, 2010

(54) DEVICE AND APPARATUS FOR MEASURING THE ENRICHMENT PROFILE OF A NUCLEAR FUEL ROD

(75) Inventor: Philippe LE TOURNEUR, Ozoir La Ferriere (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: SOC. ANONYME D'ETUDES ET REALISATIONS NUCLEAIRES, Limeil Brevannes (FR)

(21) Appl. No.: 12/772,509

(22) Filed: May 3, 2010

Related U.S. Application Data
(60) Provisional application No. 61/247,981, filed on Oct. 2, 2009.

(30) Foreign Application Priority Data
May 5, 2009 (FR) 09 52983

(51) Int. Cl. G21C 17/06

(52) U.S. Cl. 376/257

(57) ABSTRACT

Device and apparatus for measuring the enrichment profile of a nuclear fuel rod.

Thermal neutrons are used for measurement. The rod (12) comprises a longitudinal stack of fuel pellets (48). The invention uses a neutron absorbing shield (34) relative to which the rod is moved and which is provided to protect a longitudinal region of the stack against the thermal neutrons with the exception of one or more pellets included in this region, with a view to detecting the radiation they emit by interaction with the thermal neutrons and hence to deducing the enrichment profile.

### TECHNICAL FIELD

The present invention concerns a device intended to measure the enrichment profile of a nuclear fuel rod, and apparatus used to carry out this measurement.

It more particularly applies to the product control of nuclear fuel rods leaving the production line, with a view to verifying their enrichment profile in uranium-235.

### STATE OF THE PRIOR ART

It is recalled that these fuel rods are of great length (several metres) and of narrow diameter (of the order of one centimetre), consisting of pellets of uranium oxide (UO₂) which are stacked in a cladding made of a metal alloy, namely zircalloy.

It is also recalled that uranium consists of ²³⁵U isotopes(fissile) and ²³⁸U isotopes (scarcely fissile) and that enrichment is a level, namely the percentage of ²³⁵U atoms in the total number of uranium atoms. It represents 0.72% of natural uranium and is of the order of a few percent in nuclear fuel pellets.

The proper functioning of a nuclear reactor requires observance of a certain enrichment profile of the fuel rods, corresponding to a given distribution of the pellets which may have different enrichments within one same rod.

Then, measuring the enrichment profile consists of specific, quantitative measurement of the quantity of uranium-235 contained in each pellet of the rod.

This may be conducted passively, by gamma spectrometry, by causing the rod to travel in front of a suitable detector. Then, the detector detects the specific radiations of uranium-235. Such a measurement requires a sufficiently long dwell time which may be incompatible with industrial production constraints for fuel rods.

It may also be conducted actively, by detecting the response of the pellets to neutron bombardment. This active method is more accurate in that the produced signal, which uses the differences between uranium isotopes with respect to neutrons, and particularly the sensitivity of uranium-235 to these neutrons, is much more intense.

This active technique is used by manufacturers of nuclear fuel. It uses an isotopic source, typically a source of californium-252 as neutron source. It can be performed using apparatus known under the name of CRESUS, an acronym for: Contrôle Rapide d′Enrichissement Sur Uranium avant Service.

Californium sources are highly intense and require strict safety rules. The replacement of these sources by neutron generators, based on neutron tubes which solely emit when they are polarized to a very high voltage, is a general trend having regard to the increase in costs and constraints related to californium.

### DISCLOSURE OF THE INVENTION

The device, subject of the invention, is used with this type of generator, and it is included in the apparatus which is also the subject of the invention.

The neutron interrogating techniques used in the invention are conventional techniques. However the invention provides a very substantial improvement in the performance level of known measuring instruments: for example it makes it possible to reduce the intensity of the necessary neutron emission, to increase the production capacities of fuel rods, by reducing measuring time of the enrichment profile, or to increase the accuracy of results.

More precisely, the subject of the present invention is a device for measuring the enrichment profile of a nuclear fuel rod using thermal neutrons, the rod comprising a longitudinal stack of pellets of nuclear fuel, the device being characterized in that it comprises a shield made of neutron absorbing material and relative to which the nuclear fuel rod is moved during measurement, the shield being capable at all times during measurement of protecting a longitudinal region of the stack of pellets against the thermal neurons, except one or more pellets included in the longitudinal region, with a view to detecting the radiation (gamma photons or neutrons) emitted by interaction of the thermal neutrons with this or these pellets and thereby to deduce the enrichment profile.

According to one preferred embodiment of the device, subject of the invention, the shield forms a tube which has interruptions in one or more sections to define one or more openings, and through which the nuclear fuel rod is caused to move during measurement.

Preferably, the openings are irregularly spaced apart.

The length of each opening is preferably equal to or less than the length of a pellet.

According to a particular embodiment of the device, subject of the invention, the shield is formed on a tubular support which absorbs less than 10% of the thermal neutrons it receives, and in which the nuclear fuel rod is caused to move during measurement.

This tubular support can be made in a material chosen, for example, from among zircalloy, polyvinyl chloride, graphite and aluminium.

The neutron absorbing material can, for example, be chosen from among gadolinium, cadmium and lithium, more particularly lithium-6, or compounds of these elements.

The present invention also concerns an apparatus for measuring the enrichment profile of a nuclear fuel rod, using thermal neutrons, the rod comprising a longitudinal stack of pellets of nuclear fuel, the apparatus comprising:

a neutron generator, capable of emitting fast neutrons in pulse mode,

a neutron thermaliser, capable of producing thermal neutrons from fast neutrons emitted by the neutron generator,

the device subject of the invention,

at least one detector for detecting the radiation emitted by the pellet or pellets which have interacted with the thermal neutrons, and providing signals representing the enrichment of this or these pellets, the device being positioned between the detector and the neutron generator; the neutron generator, the detector and at least each part of the shield located facing the longitudinal region of the stack, being placed in the neutron thermaliser, and

an electronic system capable of determining the enrichment profile of the nuclear fuel rod from the signals delivered by the detector.

According to one particular embodiment of the apparatus, subject of the invention, the electronic system is capable of determining the enrichment profile by solving a system of linear equations relating the signals provided by the detector with the enrichments of the pellets which emit the radiation.

The apparatus may further comprise at least one collimator, to collimate the detector.

### BRIEF DESCRIPTION OF THE DRAWINGS

The present invention will be better understood on reading the description of the examples of embodiment given below solely for illustration purposes and in no way limiting, with reference to the appended drawings in which:

FIG. 1 is a schematic view of a known apparatus, allowing measurement of the enrichment profile of a nuclear fuel rod and using an isotopic source for this purpose;

FIG. 2 shows various chronograms relative to the use of a pulsed-mode neutron generator: under A, the pulses of fast neutrons produced by the generator; under B, the pulses of thermal neutrons resulting from thermalisation of the fast neutrons; under C, the total flux of thermal neutrons; under D, the total count rate of fissions resulting from interaction of the thermal neutrons with pellets of a nuclear fuel rod; and under E, the rate of prompt events, available between pulses, for measurement;

FIG. 3 is a schematic view of one particular embodiment of the apparatus, subject of the invention; and

FIG. 4 is a schematic, partial view of one preferred embodiment of the apparatus subject of the invention.

### DETAILED DESCRIPTION OF PARTICULAR EMBODIMENTS

Let us first come back to the conventional apparatus using an isotopic source generally containing californium.

This apparatus consists of two parts through which the inspected fuel rods pass.

The first part comprises the isotopic source, immersed in a thermaliser (e.g. paraffin, graphite or water) which thermalises the fast neutrons derived from the source, and creates a “bath” of thermal neutrons through which the rod will pass. During this passing, the thermal neutrons will cause fissions of the uranium-235 contained in the pellets of the rod.

The second part comprises a detection assembly which is placed at a distance of a few tens of centimetres after the source. Owing to the travel movement of the rod, the pellets which underwent fissions in the bath of thermal neutrons come to lie before the detectors of the detection assembly a few seconds or fractions of a second later.

These detectors, in practice scintillator based gamma detectors, detect the “delayed events” of fission, namely delayed gamma photons in the example under consideration, whose quantity per pellet depends on the level of enrichment of the pellet.

As a variant, neutron detectors can be used in which case the delayed neutrons emitted during fission are detected, whose quantity per pellet also depends on the level of enrichment of the pellet.

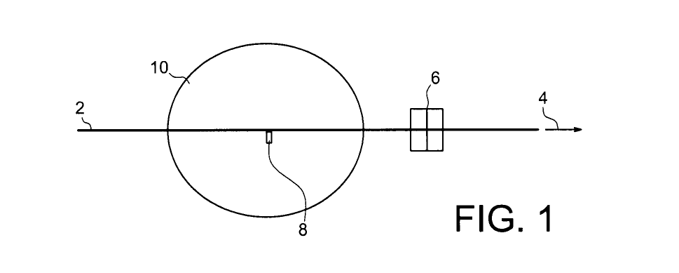

This is all schematically illustrated by FIG. 1 in which a fuel rod 2 can be seen which is caused to move using means symbolized by an arrow 4, the rod passing through the bath of thermal neutrons and then through the gamma detectors 6. The thermaliser 8 can also be seen which generates these thermal neutrons from the neutrons provided by the isotopic source 10 (source of ²⁵²Cf) which is placed in the thermaliser.

The number of delayed fission events which are detected is proportional to the uranium-235 content of the pellets (not shown) of the rod.

The recording of the detector count rates using suitable means (not shown) will directly give the enrichment profile of the rod 2.

The known apparatus, shown FIG. 1, is very simple but requires an intense source of neutrons: the intensity of the ²⁵²Cf source 10 is typically of the order of a few billion neutrons per second.

As for the speed of the rod, it is of the order of a few tens of centimetres per second.

Consideration is given below to an apparatus used to measure enrichment profiles which can be formed from a neutron generator.

Neutron generators which use the fusion of hydrogen as operating principle (deuterium-tritium reaction [DT] producing neutrons of 14 MeV or deuterium-deuterium reaction [DD] producing neutrons of 2.45 MeV), can be used in lieu and stead of the isotopic source.

Their ability to operate in pulsed mode (alternating emission of neutrons and non-emission) with variable frequency, or in continuous mode, makes it possible to consider interrogating methods other than the conventional method mentioned above which uses the isotopic source.

This conventional method, based on measurement of delayed events and used in a system with an isotopic source, can also be implemented using a neutron generator, or neutron tube, which emits neutrons by DD or DT reaction. All that is required is to replace the source by this neutron tube in the thermaliser.

This raises a problem however: the emission level to be reached is very high (higher than the usual level of current generators, although this remains feasible) so that in practice problems of cost and lifetime arise.

A further consequence is the fact that thermalisation of the neutrons will occur less easily than with the isotopic source: this source can be well confined in the matter of the thermaliser whereas the neutron tube represents a non-negligible void volume which will lead to neutron leakages.

It is noted that the choice of a neutron generator of 2.45 MeV (this energy being very close to the energy of the ²⁵²Cf neutrons) appears more expedient than a 14 MeV generator, but has increased difficulties from the viewpoint of emission level feasibility: the effective cross-section of neutron creation is one hundred times greater with DT reaction than with DD reaction.

Therefore, the reaching of one same emission level leads to a DD-reaction neutron generator which is much more complicated, heavy and costly than a DT-reaction neutron generator.

A technique is considered below which uses prompt phenomena.

Only the method of “delayed events” is accessible to an apparatus using a source such as californium-252. This is because using prompt events i.e. those which occur directly during fission, would require the detectors to be positioned in the vicinity of the location at which these fissions take place, and hence in the vicinity of the location of the source. The noise would be too intense.

The use of delayed events, having regard to their delayed occurrence after fission, allows in fact the pellets to be conveyed sufficiently far away from the source for the noise to fade. Of course, the price to be paid is a decreased signal: delayed events are less numerous than prompt events.

This last remark is of great interest; it will be appreciated that an apparatus using prompt events would normally require fewer fissions, and hence fewer neutrons, than an apparatus using delayed events which are far less numerous than prompt events.

The neutron generator makes it possible to have a “pulsed operation”: it emits a pulse of neutrons, then pauses, then emits a new pulse and so on.

During a pulse, the generator emits fast neutrons whose energy is 2.45 MeV or 14 MeV. As soon as they are emitted, they lose their energy through successive impacts and collisions in the thermaliser matter, and finish their pathway in the form of thermal neutrons whose lifetime largely exceeds the duration of the pulses.

This leads to obtaining a more or less constant level of thermal neutron flux in the apparatus if the frequency of the pulses is high enough. These thermal neutrons will cause fission reactions of the uranium-235, and these reactions will therefore also have a constant level.

If the detectors are placed beside the neutron tube, it is possible to inhibit these detectors during a pulse of fast neutrons which is a source of intense noise, and they can then be used solely between the neutron pulses.

The ability to pulse the neutron tube allows advantage to be taken of the delay in neutron thermalisation, a delay which shifts the emission of thermal neutrons and the effect of these thermal neutrons on the matter of the fuel pellets. This delay plays the same role as the delay separating prompt events from delayed events in the conventional apparatus, which uses the isotopic source.

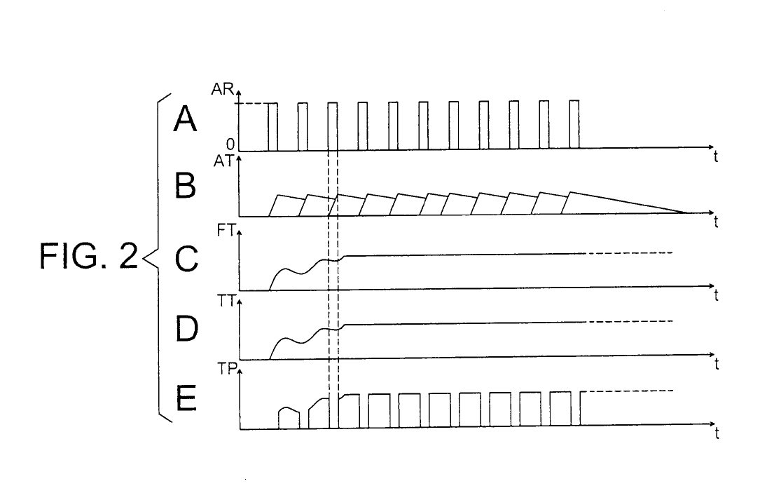

This is all schematically illustrated by FIG. 2 which shows various chronograms related to the use of a neutron generator operating in pulsed mode. Time t is given along the X-axis, and the various magnitudes along the Y-axis are expressed in arbitrary units (as a function of time).

The Y-axis gives:

in part A of FIG. 2, the amplitude AR of the pulses of fast neutrons provided by the generator,

in part B, the amplitude AT of the pulses of the thermal neutrons resulting from thermalisation of the fast neutrons,

in part C, the total flux FT of thermal neutrons (sum of all the pulses),

in part D, the total count rate TT of fissions resulting from interaction of the thermal neutrons with pellets of a nuclear fuel rod, and

in part E, the count rate TP of prompt events which are available between the pulses of fast neutrons, for measurement of the enrichment profile.

Regarding the detection of prompt events, there are several options. They are described in the literature and depend on the type of particles detected (neutrons or gamma photons), on the characterisation of these particles, on the type of detectors, and on the manner in which their emitted signals are processed.

One option of interest consists of detecting fission using a criterion of coincidence with particle detection: since fission has the property of ejecting several particles at the same time, whereas few other phenomena have this characteristic, the simultaneous detection of particles is the sign of the occurrence of a fission phenomenon.

One important aspect for the processing of these prompt events is the spatial resolution that the measuring apparatus must reach in order to be able to verify each pellet, whether or not individually.

With respect to the apparatus using delayed events, the approach is simple: the response of each pellet is obtained through correct collimation of the detectors.

With respect to an apparatus using prompt events, the problem is more difficult to solve: collimation may affect detection only (the detectors then only see one pellet at each instant) or it may more easily affect both detection and neutron interrogation.

This brings us to one particular embodiment of the present invention: by using a neutron absorbing material forming a shield against thermal neutrons, only the interrogated pellet receives thermal neutrons. This shield may for example be made of gadolinium, cadmium or lithium, preferably lithium-6 (⁶Li).

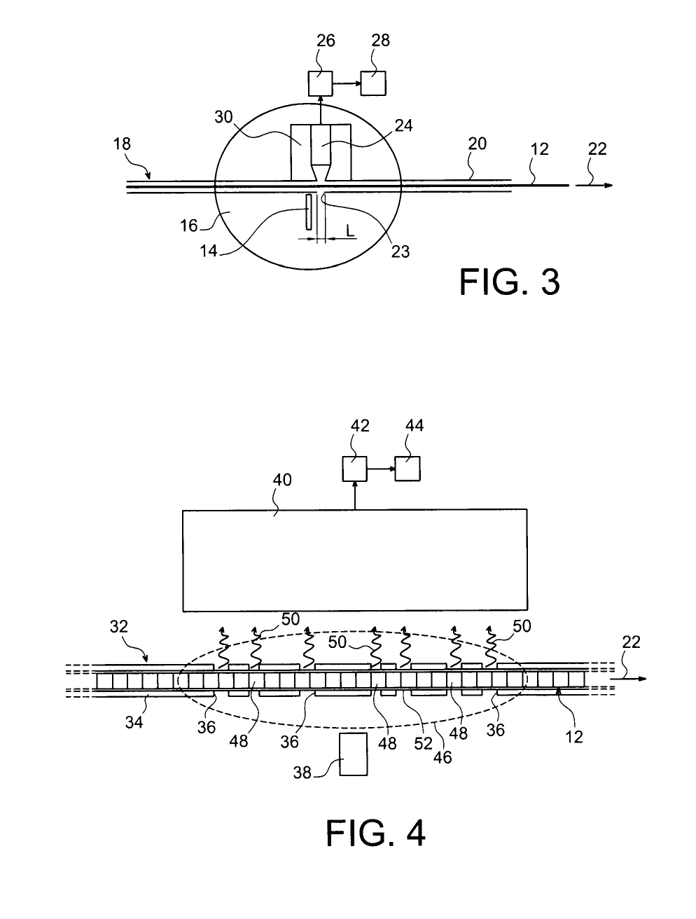

FIG. 3 is a schematic view of one particular embodiment of the apparatus subject of the invention.

The apparatus in FIG. 3 is intended to measure the enrichment profile of a nuclear fuel rod 12 using thermal neutrons, this rod 12 comprising a longitudinal stack (not shown) of nuclear fuel pellets.

The apparatus comprises a neutron generator 14 capable of emitting fast neutrons in pulsed mode (the control means of this generator are not shown), and a neutron thermaliser 16 consisting of paraffin for example, capable of producing thermal neutrons from the fast neutrons emitted by the neutron generator.

The apparatus also comprises a device 18 conforming to the invention, comprising a shield 20 made of a neutron absorbing material and relative to which the nuclear fuel rod is caused to move during measurement. The means (not shown) to move the rod are symbolised by an arrow 22.

The shield 20 is provided to give protection against the thermal neutrons, at any time during the measurement, to a longitudinal region of the stack of pellets, with the exception of one of the pellets included in the longitudinal region.

In the example shown in FIG. 3, the shield 20 forms a tube which has an interruption in one section to define an opening 23, and through which the nuclear fuel rod is passed during measurement. The length of the opening 23 is equal to the length of a pellet (typically around 1 cm), or of the order of magnitude of the pellet. Therefore only this pellet in the stack receives the thermal neutrons. By interaction with these neutrons it notably emits gamma photons.

The apparatus also comprises a detector 24 to detect these gamma photons and to deliver signals representing the enrichment of the pellet.

As can be seen FIG. 3, the device 18 is placed between the detector 24 and the neutron generator 14, and this neutron generator 14, the detector 24 and each part of the shield located facing the longitudinal region of the stack, are placed in the neutron thermaliser 16.

The apparatus further comprises an electronic system 26, capable of determining the enrichment profile of the nuclear fuel rod from the signals given by the detector 24. This system 26 is provided with means 28 for displaying the thus determined profile.

Additionally, in the example shown in FIG. 3, the apparatus comprises a collimator 30, in lead for example, which is also placed in the thermaliser 16 and is intended to collimate the detector 24.

The apparatus illustrated in FIG. 3 is therefore based on a collimated detector which observes a pellet in a window of a neutron absorbing shield. This apparatus is functional. However, its performance level is not optimal in terms of rate (rod velocity) or neutron flux.

It would be to advantage to increase the number of detectors. However this would give rise to a problem concerning the total volume of the collimators, which would reduce the volume available for neutron thermalisation.

It would also be to advantage to increase the length L of the window permitting the thermal neutrons to reach the fuel rod (length L being calculated as per the length of the rod 12).

This increase in window length would increase the count rate but would deteriorate spatial resolution: several pellets are irradiated at the same time and a distinction cannot be made between their individual responses except using a deconvolution method.

This is why, according to one preferred embodiment of the invention which is schematically and partly illustrated in FIG. 4, several windows or holes are formed in the tubular neutron absorbing material through which the rod passes. These windows are arranged in a particular pattern, lending itself well to a matrix inversion mathematical operation (see below).

More precisely, in the example in FIG. 4, the device 32 subject of the invention again comprises a shield 34 in neutron absorbing material. However, this shield forms a tube which has interruptions in several sections to define several openings 36 or windows, and the nuclear fuel rod 12 is again moved through the tube (using means symbolized by the arrow 22) during measurement.

A neutron generator 38 can also be seen, which is caused to operate in pulsed mode by means which are not shown, as well as a gamma photon detector 40. The shield 3 is again placed between this detector and the generator 38.

It is specified that the detector 40 extends opposite the group of windows 36, as can be seen in FIG. 4. Depending on the length of this group (e.g. 10 cm), it may be possible to use only one or, on the contrary, several adjacent gamma photon detectors (e.g. NaI detectors).

The thermaliser is not shown in which are placed the generator 38, the detector(s) and at least the longitudinal portion of the shield in which the openings are formed. However, the electronic system 42 can be seen which is provided to process the signals given by the detector(s), together with the display means 44 associated with the system.

The fast neutrons, generated during the functioning of the generator in pulsed mode, are thermalised. In FIG. 4 a <<cloud>>0 of thermal neutrons can be seen resulting from this thermalisation. These thermal neutrons can pass through the windows 36. Therefore in the rod 12, fissions are only caused on those pellets 48 positioned facing these windows.

At a given instant, the detector(s) therefore only collect the gamma photons 50 derived from the pellets positioned directly in front of the windows 36. At each instant, the signal given by the detection assembly (one or more detectors) is the sum of all the elementary signals resulting from all the gamma photons thus collected.

Since the neutron absorbing material is fixed with respect to the generator 38 and to the detector 40, the coefficients weighting the individual photon signals, respectively derived from the pellets lying directly in front of the windows 36, are constant.

If it is assumed for example that there are four windows, the following linear equation is obtained at a time t:

R(t)=A1.E₍ₙ₁₎+A2.E₍ₙ₂₎+A3.E₍ₙ₃₎+A4.E₍ₙ₄₎

where

R(t) is the collected signal,

Aᵢ represents the <<yield>> of one i of the four windows (where i varies from 1 to 4), i.e. the combination (1) of the thermal neutron flux which characterizes this window i (since neutron flux is stable over time) and (2) of the detecting efficiency of the detector 40 for the signals it emits, the four values A1, A2, A3 and A4 being known a priori through calibration of the apparatus (by passing a rod of known enrichment profile though this apparatus—but it is also possible to use a suitable calculation code allowing determination of coefficients Aᵢ thereby avoiding such a calibration),

E₍ₙᵢ₎ represents the enrichment of the pellet which, at time t, lies opposite the window associated with coefficient Aᵢ (1≦i≦4), and

n1, n2, n3, n4 are the respective indices of the four pellets lying opposite the windows, these indices being determined through knowledge of the rod's position.

Of course, the detector 40 gives a signal which reproduces the signal R(t) which is then processed in the system 42.

The accumulation of the different responses R(t) throughout the travel movement of the rod allows the accumulation in the electronic system 42 (comprising a computer) of a system of linear equations which can be condensed into the form of a matrix equation of R=A.E. type.

It is then possible to determine the respective enrichments of the rod pellets by solving this matrix equation to arrive at the equation: E=A′.R where:

E designates the enrichment matrix which, in one column, lists the respective enrichments of all the rod pellets,

A′ is the inverse matrix of matrix A which groups together the coefficients describing the apparatus and depending, in particular, on the windows made in the neutron absorbing material, and

R is the row matrix of the responses of the apparatus at each successive position of the rod (assuming step-by-step travel thereof).

Solely for illustration purposes and in a manner that is in no way limiting, the rod is caused to move forward in the apparatus step-by-step at a speed of a few tens of centimetres per second. And it is specified that the invention can also be implemented by causing the rod to move continuously through the apparatus, for example at the same speed of the order of a few tens of centimetres per second.

It is specified that the position of the neutron generator relative to the shield is optimized so that the <<bath>> of generated thermal neutrons is as intense as possible at the shield openings, for a given number of fast neutrons produced.

For example, for the apparatus in FIG. 4, the generator 38 can be placed 5 cm to 10 cm away from the shield 34, and equidistant from the end openings of this shield.

It is also specified that the pattern of the openings in the shield in neutron absorbing material may be chosen in relation to the number of openings, to the length of each opening, and to the distance between two adjacent openings, with a view to obtaining a matrix A which is invertible and whose inversion is as easy as possible. This inversion is better achieved the more the openings are not regularly spaced apart.

Also, in the given example, the length of each opening can be equal to the length of the nuclear fuel pellets. It may also be shorter.

However, it may also be greater; it is then still possible to determine the enrichment of each pellet using a convolution method to process the signals delivered by the detector(s) (reference is to be made to the so-called <<coded mask>> method).

In practice, the shield with windows and in neutron absorbing material can be formed from rings or tubes of cadmium, gadolinium, boron, or lithium, i.e. materials with large neutron capture cross-section. Amongst all these materials, the best are those which generate the least possible noise in the apparatus by emitting few signals when intercepting a neutron.

In this perspective, lithium 6-based materials are of great interest since their capture of a neutron does not induce a gamma event likely to be detected by the detector(s) of the apparatus.

As can be seen FIG. 4, the shield in neutron absorbing material can be formed on a tubular support 52 which absorbs less than 10%, preferably less than 1% of the thermal neutrons it receives. The rod 12 is then moved through this tubular support 52 during measurement.

This example given for the shield also applies to the apparatus in FIG. 3.

The material of the tubular support 52 can be chosen for example from among zircalloy, polyvinyl chloride, graphite and aluminium.

The advantages of the present invention are indicated below.

By using a neutron absorbing material with a given pattern, the effective inspection length is considerably increased, whilst maintaining a spatial resolution which allows analysis of the enrichment of each pellet.

The gain is effectively linear with the increase in length: by progressing from one window having a length of around 1 cm to a group of windows having a total length of 10 cm for example (accumulated lengths of the windows 36 in the example shown in FIG. 4), the gain is a factor of 10 on signal quantity.

This gain can be used directly to reduce the power of the generator, which has several consequences of interest: a reduction in radioprotection constraints, lengthening of the lifetime of the neutron tube used and a reduction in costs. This gain can also be used to increase the speed of the rods when they are being measured, and to increase the capacity of an installation manufacturing these rods.

Compared with existing equipment which uses californium-252, the invention allows an even easier changeover to neutron generators and the use of less intense neutron sources.

It is specified that the thickness of the shield in neutron absorbing material (examples in FIGS. 3 and 4) can be determined by persons skilled in the art in relation to the chosen material, so as to absorb practically all neutrons which reach it, e.g. 90% , preferably 99.9%, of these neutrons.

For example a shield in gadolinium can be used whose thickness is less than 1 mm, e.g. around 0.3 to 0.4 mm, or a shield in a compound with high lithium content (e.g. a lithium-containing resin) whose thickness is less than 10 mm, for example around 3 to 4 mm.

Also, in the examples of the invention given above, gamma photon detectors were used, but neutron detectors could just as well be used to detect the neutrons emitted by the fuel pellets when they receive the thermal neutrons. In this case the signal given by these neutron detectors would be used to determine the enrichment profile in similar manner to that described above.

Additionally, the invention can be implemented with or without a collimator: the detector(s) used may or may not be collimated. For example, the apparatus in FIG. 4 does not comprise any collimator around the detector 40, but it could be provided with one so as to only receive the radiation 50 emitted by openings 36. Such a collimator may comprise only one pierced hole for all the openings 36 or, on the contrary, several pierced holes respectively corresponding to these openings.

Further, the invention does not only apply to rods whose pellets are in uranium oxide. It also applies to rods with pellets in another material e.g. a mixed uranium-plutonium oxide.

1. A device (18, 32) for measuring the enrichment profile of a nuclear fuel rod (12) using thermal neutrons, the rod comprising a longitudinal stack of pellets (48) of nuclear fuel, the device being characterized in that it comprises a shield (20, 34) made of neutron absorbing material and relative to which the nuclear fuel rod is moved during measurement, the shield being capable at all times during measurement of protecting a longitudinal region of the stack of pellets against the thermal neutrons, except one or more pellets (46) included in the longitudinal region, with a view to detecting the radiation emitted by interaction of the thermal neutrons with this or these pellets, thereby to deduce the enrichment profile.

2. The device according to claim 1, wherein the shield (18, 32) forms a tube which has interruptions in one or more sections to define one or more openings (23, 36), and through which the nuclear fuel rod is caused to move during measurement.

3. The device according to claim 2, wherein the openings (36) are irregularly spaced apart.

4. The device according to either of claims 2 and 3, wherein the length of each opening (23, 36) is equal to or less than the length of a pellet (48).

5. The device according to any of claims 1 to 4, wherein the shield is formed on a tubular support (52) which absorbs less than 10% of the thermal neutrons it receives, and in which the nuclear fuel rod (12) is caused to move during measurement.

6. The device according to claim 5, wherein the tubular support (52) is made of a material chosen from among zircalloy, polyvinyl chloride, graphite and aluminium.

7. The device according to any of claims 1 to 6, wherein the neutron absorbing material is chosen from among gadolinium, cadmium and lithium, more preferably lithium 6, or compounds of these elements.

8. An apparatus for measuring the enrichment profile of a nuclear fuel rod (12) using thermal neutrons, the rod comprising a longitudinal stack of pellets (48) of nuclear fuel, the apparatus comprising:
a neutron generator (14, 38) capable of emitting fast neutrons in pulsed mode,
a neutron thermaliser (16) capable of producing thermal neutrons from the fast neutrons emitted by the neutron generator,
the device (18, 32) according to any of claims 1 to 7,
at least one detector (24, 40) for detecting the radiation emitted by the pellet(s) which have interacted with the thermal neutrons, and providing signals representing the enrichment of this or these pellets, the device (18, 32) being placed between the detector and the neutron generator, the neutron generator (14, 38), the detector (24, 40) and at least each part of the shield (20, 34)located facing the longitudinal region of the stack, being placed in the neutron thermaliser (16), and
an electronic system (26, 42) capable of determining the enrichment profile of the nuclear fuel rod from the signals delivered by the detector.

9. The apparatus according to claim 8, wherein the electronic system (26, 42) is capable of determining the enrichment profile by solving a system of linear equations relating the signals provided by the detector (24, 40) with the enrichments of the pellets which emit the radiation.

10. The apparatus according to either of claims 8 and 9, further comprising at least one collimator (30), to collimate the detector (24).
